(19) United States
(12) Patent Application Publication
(10) Pub. No.: US 2008/0309477 A1
(43) Pub. Date: Dec. 18, 2008

(54) Action driving signals

(76) Inventor: Pepi Dakov, Rego Park, NY (US)

Correspondence Address: Pepi Dakov, Apt 1227, 62-60 99th Street, Rego Park, NY, 11374, US

(21) Appl. No.: 12/080,410

(22) Filed: Apr. 2, 2008

Related U.S. Application Data
(60) Provisional application No. 60/921,605, filed on Apr. 3, 2007.

(51) Int. Cl. B60Q 1/50

(52) U.S. Cl. 340/467

(57) ABSTRACT

The action driver signals consists of a breaking strip of lights that is expanding is size, which by pressing the break pedal is actuated correspondingly to the amount of the breaking force, and an accelerating strip of lights that is actuated correspondingly to the amount of the applied pressure on the accelerator pedal.

### FIELD OF THE INVENTION

This invention pertains to signal lights for motor vehicles that enhance their visibility and help visualize the actions of the drivers. More specifically, it pertains to signal lights that shows changes in the speed of movement of the vehicle.

### BACKGROUND OF THE INVENTION

It is important for motor vehicles to be equipped with driving signals that would help visualize their changes in their movements so these changes can be promptly perceived by the drivers of other vehicles in the vicinity. Visualizing changes in the speed of the vehicles is important for the driver behind so they can take the necessary actions. Quick reduction of speed and stopping is most important of all and for that reason motor vehicles are equipped with break lights.

Generally, two red break lights at the rear corners of the vehicle (and a third break light higher in the middle for cars). The red break lights are linked to the breaking system and become activated when the driver pushes down the break pedal. In this way, when the break lights comes on, the drivers behind knows that the driver in the front has stepped on the brake pedal. This system generally works well in optimal conditions when visibility is good and there is a considerable distance between moving cars.

However vehicles are commonly driven in suboptimal conditions. Frequently cars in traffic are traveling with a small distance between them, and/or visibility might be reduced. This shortens the time drivers have to react. In addition driving reactions might be slower in tired, less experienced, or older drivers. Driver reactions can be substantially impaired by various substances. Unfavorable road conditions may further impede driving responses.

Frequently attention of drivers is diverted to monitoring the traffic in the rear view mirror, or to other side objects. In such cases it is extremely important to have signals lights that will allow momentarily assessment of the situation in one look. Also, an increasing amount of alarming red signal light in the peripheral vision would better attract attention of a diverted driver to a quickly stopping car in front.

Evidently, a good and quick visualization of the intentions and actions of drivers are of crucial importance for avoiding accidents.

The current signal system with break lights has important drawbacks:

does not show the driver's action to accelerate
does not show the driver's action to maintain a certain speed
does not show driver's intentions to slow down
does not show driver's intentions to stop quickly
does not distinguish a slowing down from a quick stopping
does not show a quick stopping that follows a slowing down.
does not show the speed status of a car momentarily in a glance
does not stimulate attention if watched with peripheral vision

### SUMMARY

The new inventions resolves these problems and provides for novel action driving signals that visualize the intentions and actions of drivers by showing their actions of accelerating and breaking and the intensity of these actions.

### BRIEF DESCRIPTION OF THE DRAWINGS

FIG. 1 is a perspective view of the back side of a car, which shows action driving signals placed on the back of the trunk of the car.

FIG. 2 and FIG. 3 are perspective magnified views of the back side of a car, which show the actuation of the accelerator strip portion of the action driving signals.

FIG. 4 and FIG. 5 are perspective magnified views of the back side of a car, which show the actuation of the breaking strip portion of the action driving signals.

### DESCRIPTION OF THE INVENTION

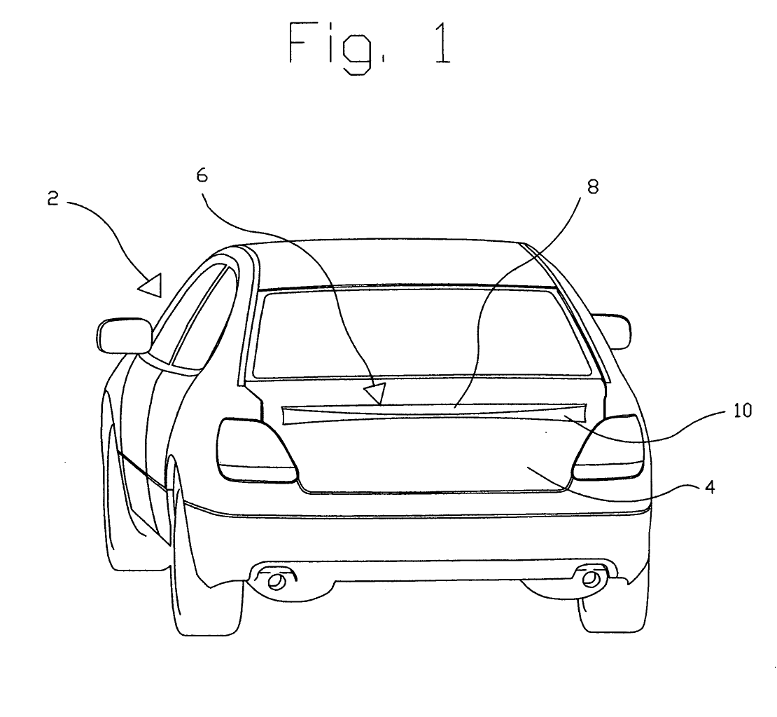

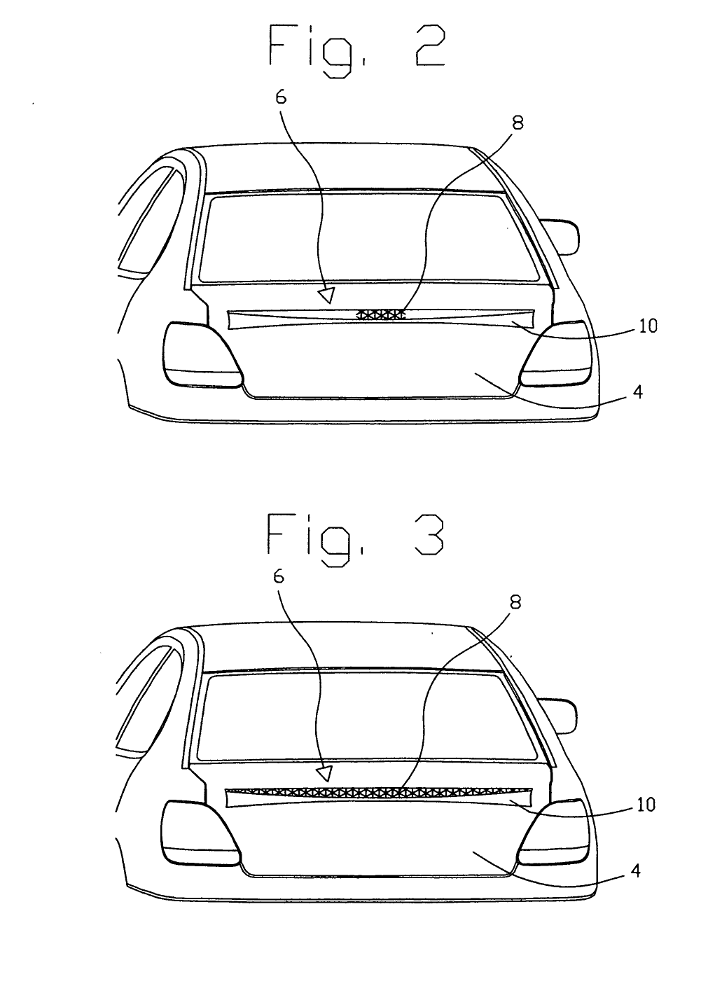

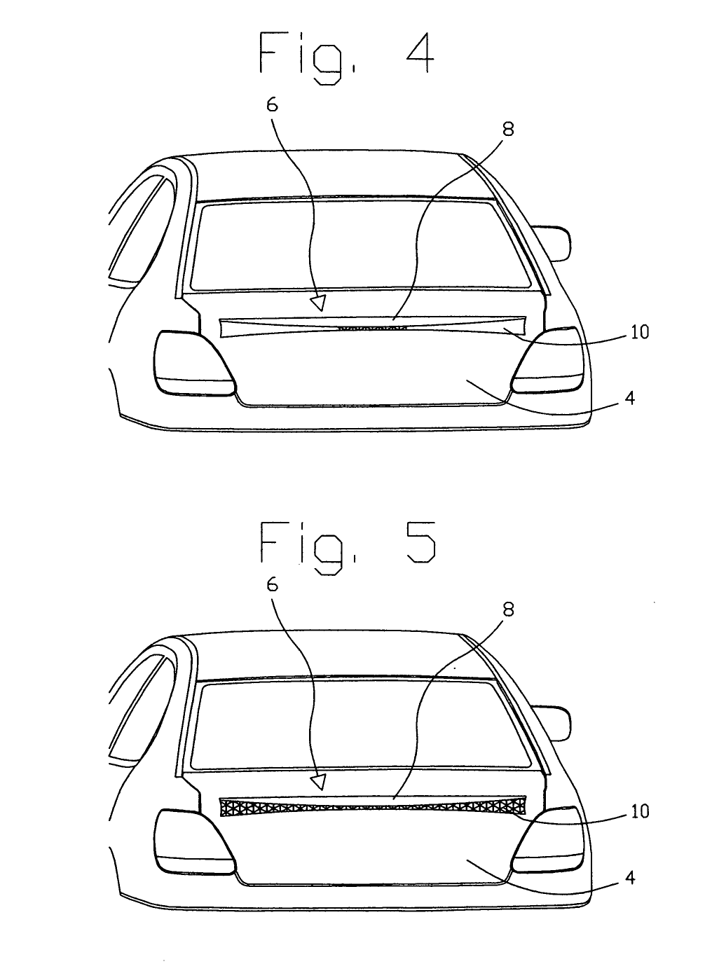

The new action driving signals are illustrated in FIG. 1 through 5. The action drives signals are positioned on the back side of the car on the trunk 4 of car a 2 (or on the rear window) stretching horizontally between the two corners. The action driving signals 6 comprise two portions—an accelerator strip 8 and a breaking strip 10. The accelerator strip is made of green lights or lights with another mild (non alarming) color. The breaking strip is made of red lights (or another alerting color).

The accelerator strip is coupled to the accelerator system. A light push on the gas pedal activates the green lights in the middle of the accelerator strip. Pushing the pedal further down activates correspondingly more lights to the sides. In this way, an increasing accelerating action of the driver is demonstrated by the strip of green lights expanding horizontally from the middle to the corners.

Driving with a maintained speed is visualized by a continuous green light in the middle of the accelerator strip. Slow removal of the foot from the gas pedal is seen by a gradual reduction and disappearance of the green lights to the middle and it demonstrates the action of slowing down and/or intentions to break down slowly. Quick removal of the foot from the gas pedal leads to a quick disappearance of the green lights, which is a sign for possible quick slowing down and stopping.

The breaking strip is coupled to the breaking system of the vehicle. A light push of the break activates the break lights in the middle of the strip. Pushing the break pedal down activates correspondingly red lights to the two sides. Slowing down is manifested by gradually expanding red lights. A quick stop is seen as a quick spread of the red lights to the periphery of the strip.

The signal lights of the two strips compliment each other. A slow reduction of the green lights of the accelerator strips followed by a slow activation of the breaking strip indicates a gradual slowing down. A quick disappearance of the green lights of the accelerator strips followed by an immediate quick spread of red lights on the breaking strips are an alarming sign for emergency breaking.

The activation of the breaking strip in accordance with the applied force makes it clear when the driver suddenly changes from a slowing down to a quick stop action.

A fully spread breaking light is a sure sign that the driver is stopping and this easy understandable with just one look. This is very important for a diverted driver returning his look to the car in front that has started a quick stopping.

Frequently, drivers need to switch lanes and their attention is diverted to the rear and side view mirrors. The traffic ahead remains in their peripheral vision. Having a red signal that increases substantially in size is more likely to attract the attention on time for reaction.

In this preferred embodiment, the accelerator strip is shown wide in the middle and narrows in the periphery. The action of removing the foot from the gas pedal is more important than the action of pressing the pedal all the way. The Increased amount of signal light in the middle provides good visualization of the process of removing the foot from the gas pedal, which is important to alert the driver behind of possible slow down or quick stop.

Also, the breaking strip is shown narrow in the middle and wider at the periphery. Pressing the break quickly all the way to the end is an extremely important sign of emergent breaking that requires immediate reaction. Visualizing this action with increased amount of red signal is important to attract the attention of the driver behind. Light breaking producing slowing is less important and for that reason it is shown with a narrow strip in the middle.

The description above and the accompanied drawings should be considered just as exemplary illustrations of the numerous various embodiments that one skill in the art can make. The accelerating and breaking portions can be positioned separately; they can be made in any shape; their lights can spread to the center or to the periphery, to the left or to the right, up down, or in combinations.

In addition, the described above system can be further modified with an electronic detection that filters out and excludes gradual changes in the acceleration and breaking actions and shows selectively only actions of quick deceleration and breaking.

The foregoing description of the principles of operation of the preferred embodiments of the action driving lights made in conjunction with the various figures of the drawings are intended to be illustrative of the practice of the invention. Without departing from the principles of operation of the present invention, other embodiments and variations can be utilized, as described above.

Thus, the information disclosed in the description of the present invention is intended to be representative of the described principles. And as certain changes may be made without departing from the scope of the invention, it is intended that all matter contained in the above description or shown in the accompanying drawings shall be interpreted as illustrative, but not in a limiting sense. It is also to be understood, that the following claims are intended to cover all of the generic and specific features of the invention herein described and all statements of the scope of the invention which, as a matter of language, might be said to fall there between.

1. Action driving signals for automobiles that visualize driver's actions of acceleration and deceleration, said driving signals comprising:
(a) a breaking strip of lights that expands exponentially in size on the back side of an automobile;
(b) means for coupling said breaking strip of lights to the breaking system of said automobile, wherein pushing the break pedal down actuates the lights of said breaking strip correspondingly to the amount of applied breaking force;
(c) an accelerator strip of lights on the back side said automobile; and
(d) means for coupling said accelerator strip of lights to the accelerator system of the car, wherein pressing down the gas pedal actuates the lights of said accelerator strip correspondingly to the amount of the applied accelerating pressure.

2. The action driving signals of claim 1 wherein said breaking strip of lights widens in size from the middle to the sides of said automobiles and pressing said breaking pedal actuates said lights of said breaking strip from said middle to said sides.

3. The action driving signals of claim 1, wherein said accelerating strip of lights widens in size from the sides to the middle of said automobile and pressing down said gas pedal actuates said lights of said accelerator strip from said middle to said sides.

4. The action driving signals of claim 2, wherein said accelerating strip of lights widens in size from the sides to the middle of said automobile and pressing down said gas pedal actuates said lights of said accelerator strip from said middle to said sides.

5. Action driving signals for automobiles that visualize driver's actions of acceleration and deceleration, said driving signals comprising:
(a) a breaking strip of lights that expands in size on the back side an automobile;
(b) means for coupling said breaking strip of lights to the breaking system of said automobile, wherein pushing the break pedal down actuates the lights of said breaking strip correspondingly to the amount of applied breaking force;
(c) an accelerator strip of lights on the back side said automobile; and
(d) means for coupling said accelerator strip of lights to the accelerator system of the car, wherein pressing down the gas pedal actuates the lights of said accelerator strip correspondingly to the amount of the applied accelerating pressure.

6. The action driving signals of claim 5 wherein said breaking strip of lights widens in size from the middle to the sides of said automobiles and pressing said breaking pedal actuates said lights of said breaking strip from said middle to said sides.

7. The action driving signals of claim 5 wherein said accelerating strip of lights widens in size from the sides to the middle of said automobile and pressing down said gas pedal actuates said lights of said accelerator strip from said middle to said sides.

8. The action driving signals of claim 5, wherein said breaking strip of lights widens exponentially and an increasing breaking force actuates exponentially more lights of said breaking strip.

9. The action driving signals of claim 8 wherein said breaking strip of lights widens exponentially in size from the middle to the sides of said automobiles and pressing said breaking pedal actuates exponentially more lights of said breaking strip from said middle to said sides.

10. The action driving signals of claim 5, wherein said accelerating strip of lights widens exponentially.

11. The action driving signals of claim 10, wherein said accelerating strip of lights widens exponentially from the sides to the middle of said automobile and pressing down said gas pedal increases the lights from said middle to said sides of said accelerating strip.

12. The action-driving signals of claim 10, wherein said breaking strip of lights widens exponentially and an increasing breaking force actuates exponentially more lights of said breaking strip.

13. The action driving signals of claim 12, wherein said breaking strip of lights widens exponentially from the middle to the sides of said automobile.

14. The action driving signals of claim 13, wherein said accelerating strip of lights widens exponentially from said sides to said middle of said automobile.

15. Action driving signals for automobiles which visualizes the amount of breaking action, said driving signals comprising:
(a) a breaking strip of lights that expands in size on the back side an automobile;
(b) means for coupling said breaking strip of lights to the breaking system of said automobile, wherein pushing the break pedal down actuates the lights of said breaking strip correspondingly to the amount of applied breaking force.

16. The action driving signals of claim 15, wherein said breaking strip of lights widens in size from the middle to the sides of said automobile and pushing down said breaking pedal actuates said breaking strip from said middle to said sides.

17. The action driving signals of claim 16, wherein said breaking strip of lights widens exponentially in size from said middle to said sides of said automobile.

18. The action driving signals of claim 16, wherein said driving signals further comprising an accelerator strip of lights on the back side said automobile; and means for coupling said accelerator strip of lights to the accelerator system of the car, wherein pressing down the gas pedal actuates the lights of said accelerator strip correspondingly to the amount of the applied accelerating pressure.

19. The action driving signals of claim 18, wherein said accelerator strip widens in size from the sides to the middle of said automobile and pressing down said gas pedal actuates said lights of said accelerator strip from said middle to said sides.

20. The action driving signals of claim 19, wherein said accelerating strip of lights widens exponentially from said sides to said middle of said automobile.
